(19) United States
(12) Patent Application Publication
(10) Pub. No.: US 2005/0263542 A1
(43) Pub. Date: Dec. 1, 2005

(54) Tiltable pouring stand for a liquid container

(76) Inventor: Keith M. Brezden, Dryden (CA)

Correspondence Address: LITMAN LAW OFFICES, LTD, PO BOX 15035, CRYSTAL CITY STATION, ARLINGTON, VA, 22215, US

(21) Appl. No.: 10/856,813

(22) Filed: Jun. 1, 2004

(51) Int. Cl. B67D 5/64

(52) U.S. Cl. 222/166

(57) ABSTRACT

A tiltable pouring stand for a liquid container with a bottom and liquid contents. The tiltable pouring stand has a raised sinuous upright base with two vertical ends, a circumferential support on the two vertical top ends of the raised sinuous upright base that wraps around and secures the liquid container, a U-shaped bottom support to hold the bottom of the liquid container, the U-shaped support is perpendicularly downwardly attached to the circumferential support and a perpendicularly upward grasping bar attached to the circumferential support to allow a user to grasp and tilt the liquid container sideways to empty the contents of the liquid container.

### BACKGROUND OF THE INVENTION

1. Field of the Invention

The present invention relates to a tiltable pouring stand for a liquid container.

2. Description of the Related Art

Buckets, pails and other containers for pourable liquids can be difficult or clumsy to handle and pour without the use of a stand or device to help pour out the liquid in the bucket, pail or container. Stands and similar devices have existed for long periods of time to address this problem and situation and are well-reflected in the related art.

U.S. Pat. No. Des. 176,897 issued to Amigone on Feb. 14, 1956, outlines the ornamental design for a holder for a bucket.

U.S. Pat. No. Des. 214,750 issued to Hawkinson on Jul. 22, 1969, outlines the ornamental design for a combined carton holder and pouring stand.

U.S. Pat. No. Des. 408,690 issued to Lin on Apr. 27, 1999, outlines the ornamental design for a support device for a water container.

U.S. Pat. No. Des. 464,850 issued to Nelson on Oct. 29, 2002, outlines the ornamental design for a water bottle holder or dispenser.

U.S. Pat. No. 1,220,640 issued to Kelly on Mar. 27, 1917, outlines the use of a barrel stand that may be easily shifted for moving a barrel from place to place and is of such construction that the barrel may be readily tilted for emptying the contents thereof.

U.S. Pat. No. 1,449,024 issued to Weittenhiller et al. on Mar. 20, 1923, outlines the use of a lifting device that is specifically adapted to lift barrels, which will lift a barrel from the floor, which will hold the barrel at any desired angle, which may be easily manipulated and be of an extremely simple design and may be cheaply constructed from standard material.

U.S. Pat. No. 1,641,985 issued to Nichols on Sep. 13, 1927, outlines the use of a relatively portable frame for disposition over a drum together with a way of attaching to the drum, that is carried by chains or cables wound upon a shaft for hoisting the drum and permitting the drum to be properly tilted when in a hoisted position.

U.S. Pat. No. 1,803,797 issued to Gerhardt on May 5, 1931, outlines the use of a stand or support for barrels or casks containing oils, kerosene, alcohol or other liquids generally used by filling stations, grocery stores, drug stores or other places where liquids are dispensed in small quantities from a large and heavy container without the necessity of attendants having to lift or tilt the container to draw the liquid.

U.S. Pat. No. 1,814,342 issued to Smith on Jul. 14, 1931, outlines the use of a holder and stand which may be employed for tiltably supporting a container in such a manner as to facilitate the pouring of the contents from such a container and which may also be employed to adjustably support various objects.

U.S. Pat. No. 2,708,558 issued to Pedersen on May 17, 1955, outlines the use of a portable knockdown structural entity which has to do with ways for tiltably supporting comparatively heavy and unwieldy five-gallon liquid filled cans and has particular reference to a two-part assemblage characterized by a stand and a cradling rack tiltably mounted on the stand.

U.S. Pat. No. 2,745,616 issued to Gomes on May 15, 1956, outlines the use of a device for supporting or holding a jar, bottle, demijohn or like vessel for holding liquid in such a manner that it is securely held in position against accidental displacement on a base to pour out its contents into a glass or other receptacle that can be readily tilted for discharging the contents with little physical exertion on the part of the operator.

U.S. Pat. No. 2,813,693 issued to Puddicombe et al. on Nov. 19, 1957, outlines the use of a device for holding large generally cylindrical containers for convenience and ease in pouring contents therefrom. In particular, the device has a novel pour stand, which will accommodate either circular or square containers of selected capacity and standard construction, which would include five-gallon round and five-gallon square cans.

U.S. Pat. No. 3,150,852 issued to Larkin on Sep. 29, 1964, outlines the use of a pouring stand formed of wire for supporting large milk bottles, in which the stand is formed with a pair of upright frame portions and a separable suspension cradle. The milk bottle is suspended revolvably by trunnions set in journals being provided to axially restrain the large milk bottle and limit stopping capability so that it may be readily tilted in either direction with predetermined limits for pouring.

U.S. Pat. No. 5,890,686 issued to Morales on Apr. 6, 1999, outlines the use of a water bottle swing that is rotatably attached to a stand with a swing assembly. In use, a water bottle is situated within the swing assembly so that the water may be easily dispensed therefrom. A rigid retainer with a loop wire having a linear portion with a first end coupled to the swing assembly is provided. The loop wire further has a second end with a circular loop portion formed thereon.

U.S. Pat. No. 6,575,337 issued to Malavear on Jun. 10, 2003, outlines the use of a pouring device for facilitating pouring material from a cook pot into a container. The pouring device includes a base portion being designed for resting on a support surface, with the base portion designed for receiving a container. A pair of support portions is positioned on the base portion and an axle portion is coupled between the support portions where the support portions support the axle portion above the base portion. The support portions are removable from the base portion to allow for easier clean up of the base portion.

German Patent No. DE 4,016,609 granted to Hubert on Nov. 28, 1991, outlines the use of a two-wheeled cart for buckets containing pourable liquid material. The cart has a frame tiltable relative to its wheels with a pair of grip bars, a stand and a support for a bucket. It also has a suspension harness connected to a conventional bucket to form a separate unit, has diametric bearing journals to determine a horizontal pivot axis of the unit and has bearing apertures in the frame to accommodate the journals when tilted. The unit thusly forms a gondola, pivotaly suspended in the frame, with a center of gravity below the horizontal pivot axis of the gondola.

Great Britain Patent No. 2,269,374 granted to Perry on Aug. 8, 1992, outlines the use of a storage rack for beer barrels, which has a sub-frame for receiving a barrel pivotally connected thereto and a way of tilting the sub-frame relative to the main frame in response to a weight reduction of the barrel as beer is drawn off. The way of tilting utilizes springs releasably mounted in tubes and the sub-frame may be connected to the main frame on the other side of the center of gravity of the sub-frame and barrel combination.

Although each of the devices outlined in these patents outline the use of novel and useful devices that make it easier for a person to pour liquid out of a particular bucket, pail or other container, these devices are low to the ground and often require a person to bend-down in order to use the device. What is really needed is a device to easily pour out liquid from a bucket, pail or other container that is set high enough for a person to use without bending-down. Such a device would be well-received in the marketplace and would address a high demand in the marketplace.

None of the above inventions and patents, taken either singly or in combination, are seen to describe the instant invention as claimed. Thus a tiltable pouring stand for a liquid container solving the aforementioned problems is desired.

### SUMMARY OF THE INVENTION

The invention is a tiltable pouring stand for a liquid container with a bottom and liquid contents. The tiltable pouring stand has a raised sinuous upright base with two vertical ends, a circumferential support on the two vertical top ends of the raised sinuous upright base that wraps around and secures the liquid container, a U-shaped bottom support to hold the bottom of the liquid container, the U-shaped support is perpendicularly downwardly attached to the circumferential support and a perpendicularly upward grasping bar attached to the circumferential support to allow a user to grasp and tilt the liquid container sideways to empty the contents of the liquid container.

Accordingly, it is a principal object of the invention to provide a device that enables a user to easily pour liquid out of a five-gallon container.

It is another object of the invention to provide a device that can easily pour liquid out of a five-gallon container without a user having to bend over in order to use.

It is a further object of the invention to provide a tiltable pouring stand for liquid a container that is rust-free.

Still another object of the invention is to provide a tiltable pouring stand for a liquid container that is lightweight and able to be easily broken-down for easy storage.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a tiltable pouring stand for a liquid container according to the present invention.

FIG. 2 is a top side perspective view of a tiltable pouring stand for a liquid container that is in an upright closed position.

FIG. 3 is a top side perspective view of a tiltable pouring stand for a liquid container that is in a tilted open position.

Similar reference characters denote corresponding features consistently throughout the attached drawings.

### DETAILED DESCRIPTION OF THE PREFERRED EMBODIMENT

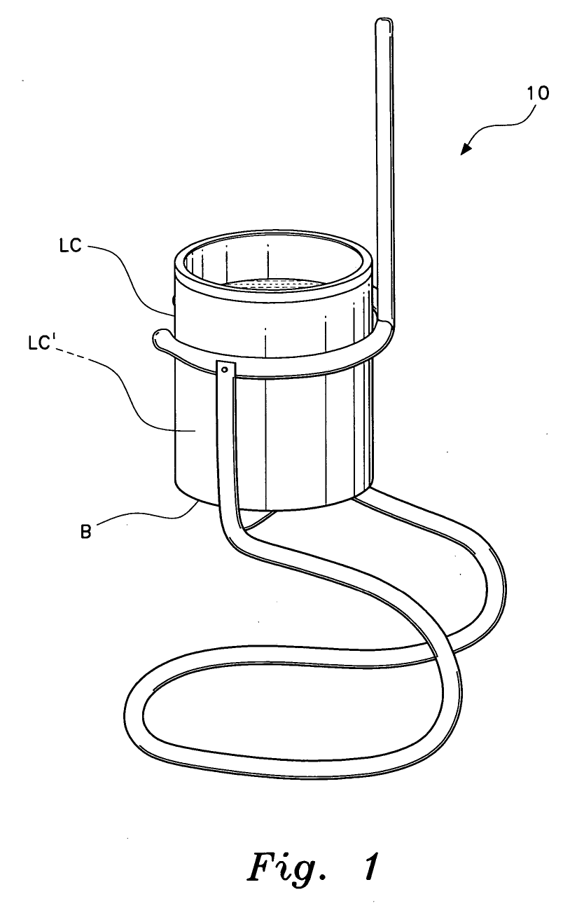

The present invention is a tiltable pouring stand for a liquid container 10 with a bottom B, a liquid container LC and liquid contents LC′, as are depicted in FIG. 1.

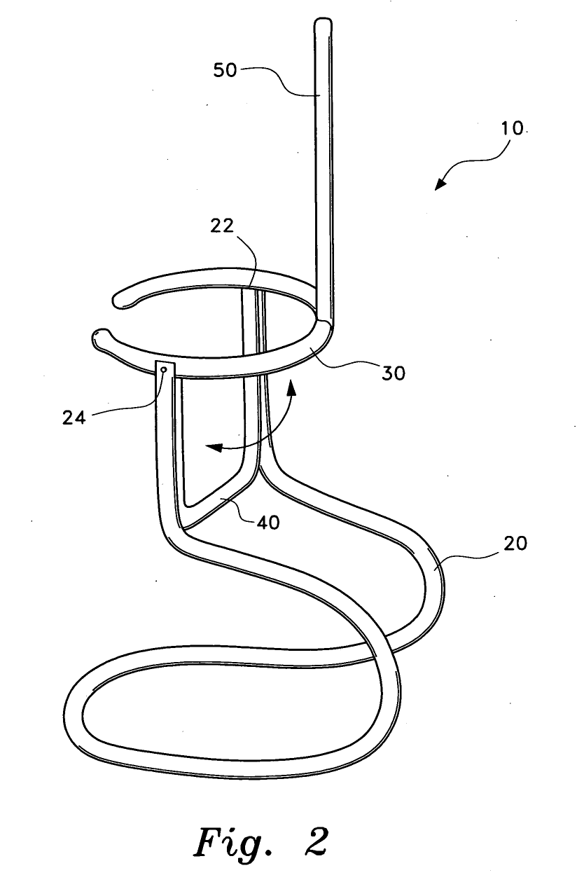

As is depicted in FIG. 2, the tiltable pouring stand for a liquid container 10 comprises a raised sinuous upright base 20 with two vertical ends 22,24, a circumferential support 30 attached to the two vertical ends 22,24 of the raised sinuous upright base 20 that that wraps around and secures the liquid container LC, a U-shaped bottom support 40 to hold the bottom B of the liquid container LC, the U-shaped support 40 is perpendicularly downwardly attached to the circumferential support 30 and a perpendicularly upward grasping bar 50 attached to the circumferential support 30 to allow a user to grasp and tilt the liquid container LC sideways to empty the liquid contents LC′.

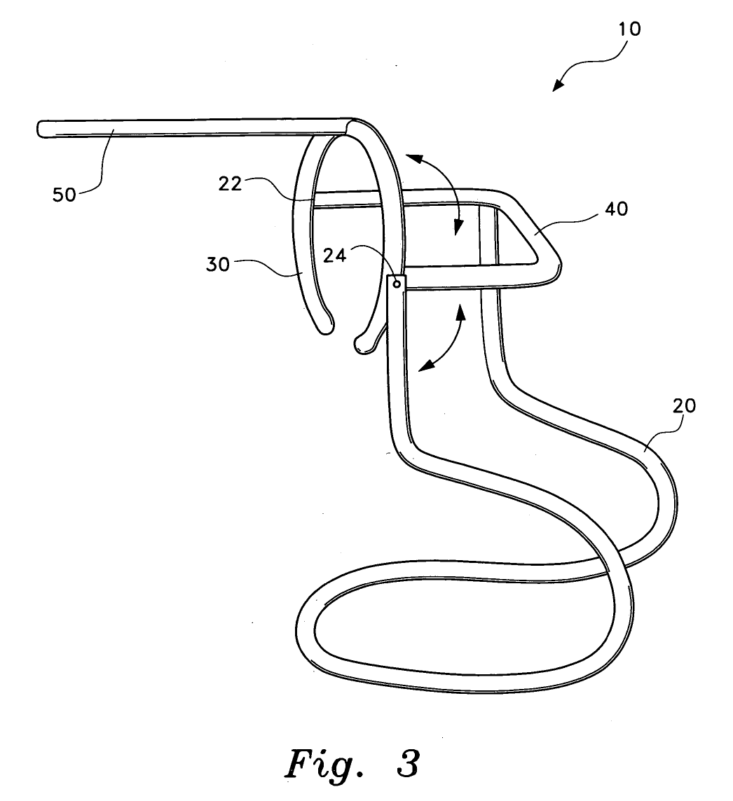

The tiltable pouring stand for a liquid container 10, the circumferential support 30, the U-shaped bottom support 40, the perpendicularly upward grasping bar 50 and the secured liquid container LC are tiltable forward and backwards to the raised sinuous upright base 20 to pour the liquid contents LC′ out of the liquid container LC. This is illustrated in FIG. 3, which depicts the tiltable pouring stand for a liquid container 10 being tilted forward 900 and being in a position to pour the liquid contents LC′ of the liquid container LC out of the liquid container LC. It is assumed that the liquid container LC is provided with a device, such as a nozzle, that provides an aperture in the top of the liquid container (top not shown) for the liquid contents LC′ to pour out of. Such nozzles are very well known in the related art and can easily be used with the liquid container LC.

Use of the tiltable pouring stand for a liquid container 10 is straightforward. The tiltable pouring stand for a liquid container 10 is made of non-corrosive galvanized metal, which will keep the tiltable pouring stand for a liquid container 10 from rusting or corroding. The tiltable pouring stand for a liquid container 10 is designed to hold and accommodate five-gallon containers with a cylindrical shape or a squared-off shape, although it is not limited to five-gallon containers. The ends of the circumferential support 30 can also be clasped together to further secure a liquid container LC being secured. The circumferential support 30 is rigid enough, however, to comfortably hold a standard five-gallon container without clasping the ends of the circumferential support 30.

The tiltable pouring stand for a liquid container 10 is relatively lightweight and can be broken-down into two pieces for easy storage. The tiltable pouring stand for a liquid container 10 can be used indoors or outdoors by campers, recreational vehicle owners, outdoorsmen and anyone who wants to haul and pour liquids. A user can easily grasp the grasping bar 50 and can pull the tiltable assembly 30,40,50 towards themselves and gravitationally pour the liquid contents LC′ of the liquid container LC into a desired smaller container or vessel.

It is to be understood that the present invention is not limited to the embodiment described above, but encompasses any and all embodiments within the scope of the following claims.

1. A tiltable pouring stand for a liquid container with a bottom and liquid contents, comprising:
a raised sinuous upright base with two vertical top ends;
a circumferential support on the two vertical top ends of the raised sinuous upright base that wraps around and secures the liquid container;
a U-shaped bottom support to hold the bottom of the liquid container, said U-shaped support is perpendicularly downwardly attached to the circumferential support; and
a perpendicularly upward grasping bar attached to the circumferential support to allow a user to grasp and tilt the liquid container sideways to empty the contents of the liquid container, said circumferential support, the U-shaped bottom support, the perpendicularly upward grasping bar and the secured liquid container are tiltable forward and backwards to the raised sinuous upright base to pour the liquid contents out of the liquid container.

2. The pouring stand according to claim 1, wherein the pouring stand is made of non-corrosive galvanized metal.

3. The pouring stand according to claim 1, wherein the liquid container being secured is a five-gallon container.
